(19) United States
(12) Patent Application Publication
(10) Pub. No.: US 2015/0016530 A1
(43) Pub. Date: Jan. 15, 2015

(54) EXHAUSTIVE SUB-MACROBLOCK SHAPE CANDIDATE SAVE AND RESTORE PROTOCOL FOR MOTION ESTIMATION

(71) Applicants: James M. Holland, Folsom, CA (US); Jason D. Tanner, Folsom, CA (US)

(72) Inventors: James M. Holland, Folsom, CA (US); Jason D. Tanner, Folsom, CA (US)

(21) Appl. No.: 13/977,302

(22) PCT Filed: Dec. 19, 2011
(86) PCT No.: PCT/US11/65726

§ 371 Date: Jun. 23, 2014

(51) Int. Cl. H04N 19/423; H04N 19/51; H04N 19/583

(52) U.S. Cl. CPC H04N 19/00484; H04N 19/00733; H04N 19/00684
USPC 375/240.16

(57) ABSTRACT

Systems, devices and methods are described including using a motion search engine of a video encoder to obtain search results for a motion predictor where the search results include a best motion vector result for each of a set of macroblock and/or sub-macroblock shape candidates of a source macroblock. The engine may then provide the search results including motion vector results for all the shape candidates as output to a motion search controller. The controller may then provide the first search results back to the search engine when the controller requests that the engine obtain second search results for another motion predictor. When doing so, the engine may use the first search results as initial conditions for performing a motion search using the other motion predictor.

### BACKGROUND

Motion estimation based on temporal prediction is an important process in advanced video encoders. In motion estimation, multiple areas may be searched to find the best match for the purposes of temporal motion estimation. In doing so, local regions are usually searched around a variety of predictor locations that can be either random, calculated based on neighboring macroblocks or based on other methods. However, motion, particularly in high definition frames, may exceed a limited search range by a significant amount. Further, in cases of complicated motion, a portion of a macroblock may be scattered in different sections of a video frame. To be able to more accurately capture extensive and/or complicated motion would improve compression efficiency.

Most software based encoders perform motion searches based on individual predictors and are typically not power or performance efficient. In addition, most software based encoders search using a singular block size (such as 16×16) and then check other block or sub-block shapes in a limited local region. Traditional hardware based motion estimation engines search a fixed block region of limited size (such as 48×40) but do not leverage information obtained from searches performed across multiple fixed regions. Such engines are typically either isolated to obtaining results for a single region or to obtaining the best call from multiple isolated regions.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example video encoder system;

FIG. 2 is an illustrative diagram of an example motion estimation module;

FIG. 3 is an illustrative diagram of an example motion estimation scenario;

FIG. 4 is a flow diagram illustrating an example motion search process;

FIG. 5 is an illustrative diagram of an example sequence chart;

FIG. 6 is an illustrative diagram of example search result contents;

FIG. 7 is an illustrative diagram of example shape candidates;

FIGS. 8, 9 and 10 are illustrative diagrams of example search result contents;

FIG. 11 is an illustrative diagram of an example system; and

FIG. 12 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

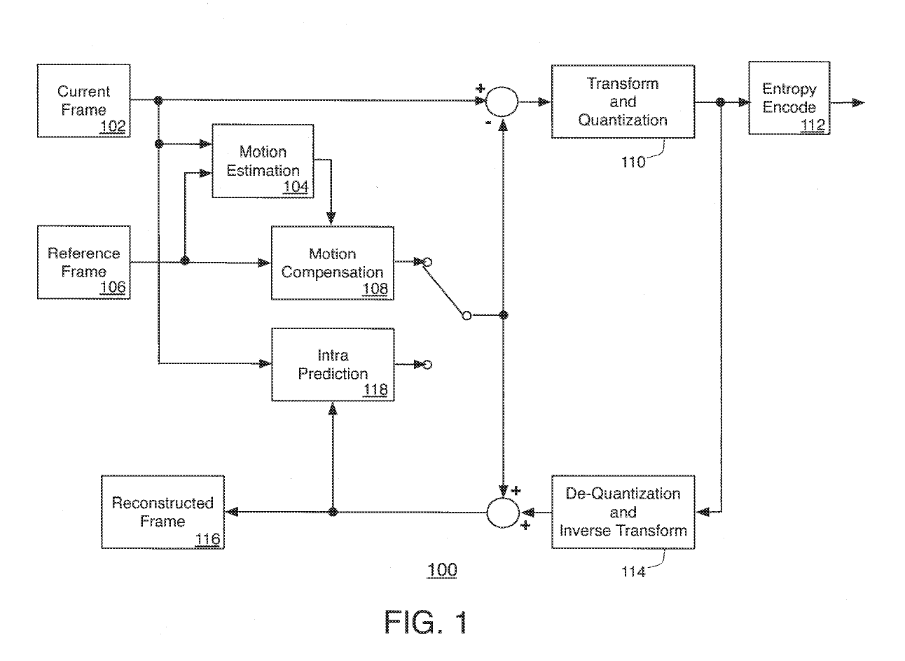

FIG. 1 illustrates an example video encoder system 100 in accordance with the present disclosure. In various implementations, video encoder system 100 may be configured to undertake video compression and/or implement video codecs according to one or more advanced video codec standards, such as, for example, the H.264/AVC standard (see ISO/IEC JTC1 and ITU-T, H1.264/AVC—Advanced video coding for generic audiovisual services,” ITU-T Rec. H.264 and ISO/IEC 14496-10 (MPEG-4 part 10), version 3, 2005)(hereinafter: the “AVC standard”) and extensions thereof including the Scalable Video Coding (SVC) extension (see Joint Draft ITU-T Rec. 11.264 and ISO/EC 14496-10/Amd.3 Scalable video coding, Jul. 5, 2007)(hereinafter the “SVC standard”). Although system 100 and/or other systems, schemes or processes may be described herein in the context of the AVC standard, the present disclosure is not limited to any particular video encoding standard or specification. For example, in various implementations, encoder system 100 may be configured to undertake video compression and/or implement video codecs according to other advanced video standards such as VP8, MPEG-2, VC1 (SMPTE 421M standard) and the like.

In various embodiments, a video and/or media processor may implement video encoder system 100. Various components of system 100 may be implemented in software, firmware, and/or hardware and/or any combination thereof. For example, various components of system 100 may be provided, at least in part, by hardware of a computing system or system-on-a-chip (SoC) such as may be found in a computing device, communications device, consumer electronics (CE) device or the like. For instance, at least part of system 100 may be provided by software and/or firmware instructions executed by processing logic such as one or more central processing unit (CPU) processor cores, a digital signal processor (DSP), an application specific integrated circuit (ASIC), a Fully Programmable Gate Array (FPGA), and so forth.

In encoder system 100, a current video frame 102 may be provided to a motion estimation module 104. System 100 may process current frame 102 in units of image macroblocks. When encoder system 100 is operated in inter-prediction mode (as shown), motion estimation module 104 may generate a residual signal in response to current video frame 102 and a reference video frame 106. A motion compensation module 108 may then use the reference video frame 106 and the residual signal provided by motion estimation module 104 to generate a predicted frame. The predicted frame may then be subtracted from the current frame 102 and the result provided to a transform and quantization module 110. The block may then be transformed (using a block transform) and quantized to generate a set of quantized transform coefficients which may be reordered and entropy encoded by an entropy encoding module 112 to generate a portion of a compressed bitstream (e.g., a Network Abstraction Layer (NAL) bitstream) provided by video encoder system 100. In various implementations, a bitstream provided by video encoder system 100 may include entropy-encoded coefficients in addition to side information used to decode each block (e.g., prediction modes, quantization parameters, motion vector information, and so forth) and may be provided to other systems and/or devices as described herein for transmission or storage.

The output of transform and quantization module 110 may also be provided to a de-quantization and inverse transform module 114. De-quantization and inverse transform module 114 may implement the inverse of the operations undertaken by transform and quantization module 110 and the output of de-quantization and inverse transform module 114 may be combined with the predicted frame to generate a reconstructed frame 116. When encoder system 100 is operated in intra-prediction mode, an intra prediction module 118 may use reconstructed frame 116 to undertake known intra prediction schemes that will not to be described in greater detail herein. Those skilled in the art may recognize that video encoder system 100 may include additional components (e.g., filter modules and so forth) that have not been depicted in FIG. 1 in the interest of clarity.

In general, frame 102 may be partitioned for compression by system 100 by dividing frame 102 into one or more slices of macroblocks (e.g., 16×16 luma samples with corresponding chroma samples). Further, each macroblock may also be divided into macroblock partitions and/or into sub-macroblock partitions for motion-compensated prediction. As used herein, the term “block” may refer to a macroblock, a macroblock partition, or to a sub-macroblock partition of video data. In various implementations in accordance with the present disclosure, macroblock partitions may have various sizes and shapes including, but not limited to 16×16, 16×8, 8×16, while sub-macroblock partitions may also have various sizes and shapes including, but not limited to, 8×8, 8×4, 4×8 and 4×4. It should be noted, however, that the foregoing are only example macroblock partition and sub-macroblock partition shapes and sizes, the present disclosure not being limited to any particular macroblock partition and sub-macroblock partition shapes and/or sizes.

In various implementations, a slice may be designated as an I (Intra), P (Predicted), B (Bi-predicted), SP (Switching P) or ST (Switching I) type slices. In general, a frame may include different slice types. Further, fiames may be designated as either non-reference frames or as reference frames that may be used as references for interframe prediction. In P slices, temporal (rather than spatial) prediction may be undertaken by estimating motion between frames. In B slices, two motion vectors, representing two motion estimates per macroblock partition or sub-macroblock partition may be used for temporal prediction or motion estimation. In addition, motion may be estimated from multiple pictures occurring either in the past or in the future with regard to display order. In various implementations, motion may be estimated at the macroblock level at the various macroblock or sub-macroblock partition levels corresponding, for example, to 16×8, 8×16, 8×8, 8×4, 4×8, or 4×4 shape and sizes mentioned above.

In various implementations, a distinct motion vector may be coded for each macroblock or sub-macroblock partition. During motion estimation processing a range of sub-macroblock shape candidates (e.g., 16×16, 16×8, 8×16, 8×8, 8×4, 4×8 and 4×4) may be searched, and a motion estimation scheme that optimizes the trade-off between the number of bits necessary to represent the video and the fidelity of the result may be implemented.

In various implementations, temporal prediction for a source macroblock may be undertaken by searching multiple target regions in one or more reference frames as identified by two or more predictors associated with the source macroblock. In various implementations, predictors may be determined at random, may be determined based on neighboring macroblocks, or may be determined based on various other known methods.

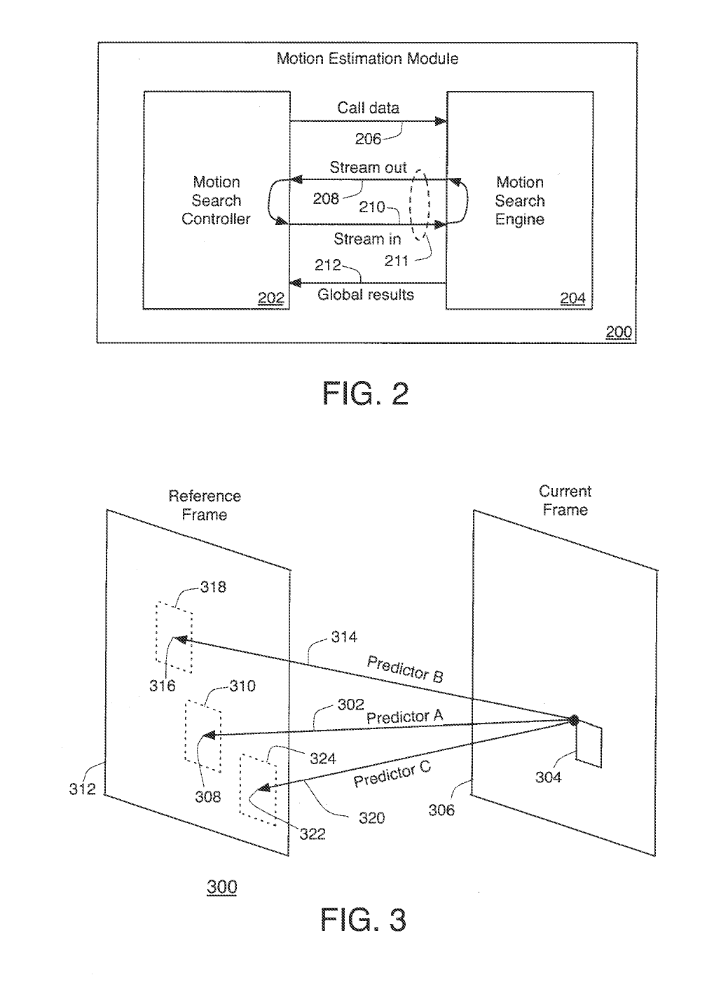

In various embodiments, when undertaking motion estimation processing, video encoder system 100 may employ motion estimation module 104 to implement motion estimation (ME) schemes using multiple macroblock or sub-macroblock partition shape candidates in accordance with the present disclosure. FIG. 2 illustrates an example ME module 200 in accordance with the present disclosure. By way of non-limiting example, ME module 200 may be implemented by module 104 of video encoder system 100.

In various implementations, ME module 200 includes a motion search controller 202 and a motion search engine 204. In various embodiments, engine 204 may be implemented in hardware, while software may implement controller 202. For example, engine 204 may be implemented by ASIC logic while controller 202 may be provided by software instructions executed by general purpose logic such as one or more CPU cores. However, the present disclosure is not limited in this regard and controller 202 and or engine 204 may be implemented by any combination of hardware, firmware and/or software.

In accordance with the present disclosure, module 200 may use controller 202 and engine 204 to implement various motion estimation schemes. As will be explained in greater detail below, controller 202 may, in combination with engine 204, undertake multiple motion searches for any particular source block to be predicted in a current frame. For example, for a given macroblock, controller 202 may use engine 204 to undertake a series of motion searches where each search is undertaken using a different motion predictor. FIG. 3 illustrates an example motion estimation scenario 300 that will be used herein to aid in the discussion of motion search processes undertaken by module 200.

In various implementations, when undertaking temporal prediction for a macroblock, controller 202 may issue a series of motion search calls to engine 204 where each search call may be specified by call data 206 input to engine 204. For each search call, call data 206 may specify at least a target search area and location and a source macroblock location. In addition, as will be explained in further detail below, call data 206 may include or may be associated with an input message to engine 204 where the input message may include results of a previous motion search undertaken by engine 204.

For instance, referring to example scenario 300, a first search call issued by controller 202 may correspond to a first predictor 302 (predictor A) associated with a source macroblock 304 in a current frame 306. Call data 206 may specify the location of source macroblock 304 in frame 306, as well as the location 308 of a target area 310 in a reference frame 312 as pointed to by first predictor 302. Search engine 204 may then perform a motion search within target area 310 in response to the search call. When doing so, engine 204 may obtain search results including a best motion vector result for each of various macroblock and/or sub-macroblock partitions of source block 304.

In accordance with the present disclosure, and as will be explained in greater detail below, search engine may provide or stream out (208) the search results of the first search call to controller 202 where those search results include at least a best motion vector result for each macroblock and/or sub-macroblock partition searched. Subsequently, a second search call issued by controller 202 may correspond to a second predictor 314 (predictor B) associated with source block 304. Call data 206 accompanying the second search call may specify the location of source block 304, as well as the location 316 of a second target area 318 in frame 312 as pointed to by the second predictor 314. Search engine 204 may then perform a motion search within the second target area 318. When doing so, engine 204 may obtain search results including best motion vectors for at least the same macroblock and/or sub-macroblock partitions of source block 304 that were employed to conduct motion searches in response to the first call.

In accordance with the present disclosure, as noted above and as will be explained in greater detail below, when issuing the second motion search call to engine 204, controller 202 may provide or stream in (210) the search results of the first motion call to engine 204 in the form of an input message. In response, engine 204 may use the search results of the first motion call as initial conditions for the motion search it conducts in response to the second call. For example, engine 204 may use each best motion vector result appearing in the first call's search results as the initial search candidate for the motion search undertaken for the corresponding macroblock or sub-macroblock partition in response to the second search call. In various implementations, stream out 208 and stream in 210 may form a stream in stream out interface 211.

Subsequently, a third search call issued by controller 202 may correspond to a third predictor 320 (predictor C) associated with source block 304. Call data 206 accompanying the third search call may specify the location of source block 304, as well as the location 322 of a third target area 324 in frame 312 as pointed to by the third predictor 320. Search engine 204 may then perform a motion search within the third target area 324. When doing so, engine 204 may obtain search results including best motion vectors for at least the same macroblock and/or sub-macroblock partitions of source block 304 that were used to conduct motion searches in response to the first and second calls. As above, when issuing the third motion search call to engine 204, controller 202 may provide or stream in (210) the search results of the second motion call to engine 204 in the form of another input message. In response, engine 204 may use the search results of the second motion call as initial conditions for the motion search it conducts in response to the third call. For example, engine 204 may use each best motion vector result appearing in the search results of the second call as the initial search candidate for the motion search undertaken for the corresponding macroblock or sub-macroblock partition in response to the third search call.

Further, as will be explained in greater detail below, engine 204 may use the search results of a subsequent call to update the search results of a previous call. For example, the results of the second call may be updated with the results of the first call. The updated search results may then be provided in the input message for the third call and used as initial conditions for the third motion search. In various implementations, using the search results of the second call to update the search results of the first call may include combining the search results into a global search result by selecting, for each macroblock and sub-macroblock partition of source block 302, a best motion vector from among the first and second search results. Likewise, the results of the third call may be updated using the combined results of the first and second calls.

Controller 202 and engine 204 may continue to perform actions as described above for any number of additional predictors (not shown) of source block 304. When doing so, engine 204 may perform motion searches based on serially updated global search results that are streamed out to controller 202 at the end of each motion search and then streamed back in the engine 204 to be used as initial candidates for a next motion search based on a next predictor.

Although FIG. 3 depicts all three predictors 302, 314 and 320 as pointing to a single reference frame 312, in various implementations, different predictors may point to different reference frames. Further, while FIG. 3 depicts a scenario 300 having only three motion predictors 302, 314 and 320, the present disclosure is not limited to any particular number of motion searches undertaken for a given macroblock and, in various implementations, any number of motion predictors may be employed.

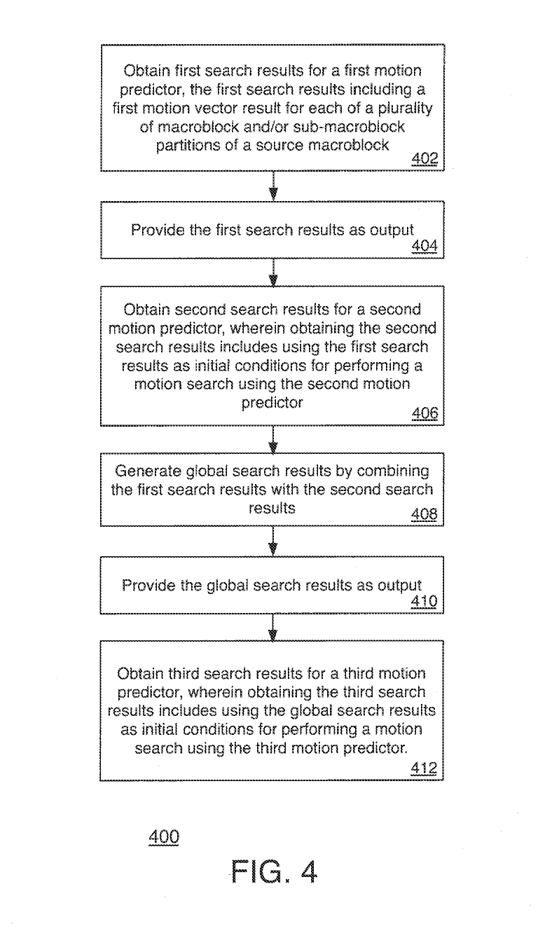

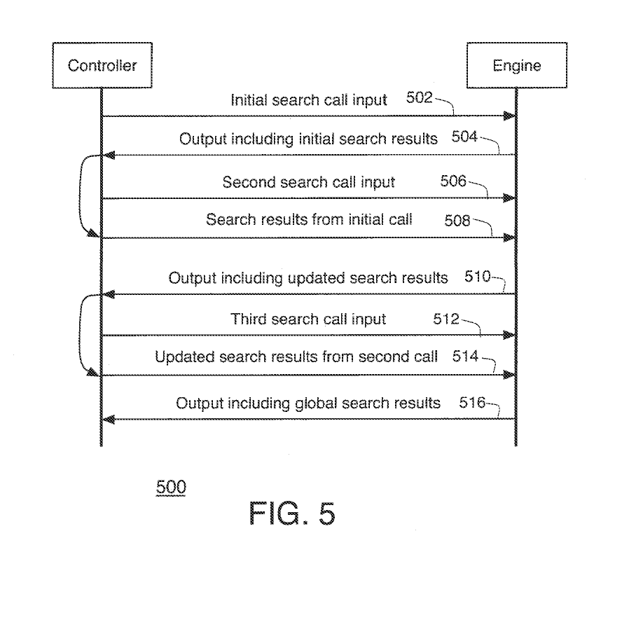

FIG. 4 illustrates a flow diagram of an example process 400 according to various implementations of the present disclosure. Process 400 may include one or more operations, functions or actions as illustrated by one or more of blocks 402, 404, 406, 408, 410 and 412 of FIG. 4. By way of non-limiting example, process 400 will be described herein with reference to example motion estimation module 200 of FIG. 2 and example scenario 300 of FIG. 3. Further, and also by way of non-limiting example, process 400 will be described herein with reference to an example sequence chart 500 as depicted in FIG. 5. In various implementations, process 400 may form at least part of a save and restore protocol between a motion search controller and a motion search engine.

Process 400 may begin at block 402 where search results for a first motion predictor may be obtained, where the first search results include a first motion vector result for each of a plurality of macroblock and/or sub-macmblock partitions of a source macroblock. In various implementations, block 402 may involve engine 204 obtaining search results in response to a first search call received from controller 202. For instance, controller 202 may issue an initial search call 502 to engine 204 where that call specifies a motion search using predictor 302. Engine 204 may then use predictor 302 to perform a motion search in region 310 to generate motion vector results for a variety of macroblock or sub-macroblock partitions such as, for example, 16×8, 8×16, 8×8, 8×4, 4×8, and/or 4×4 partitions.

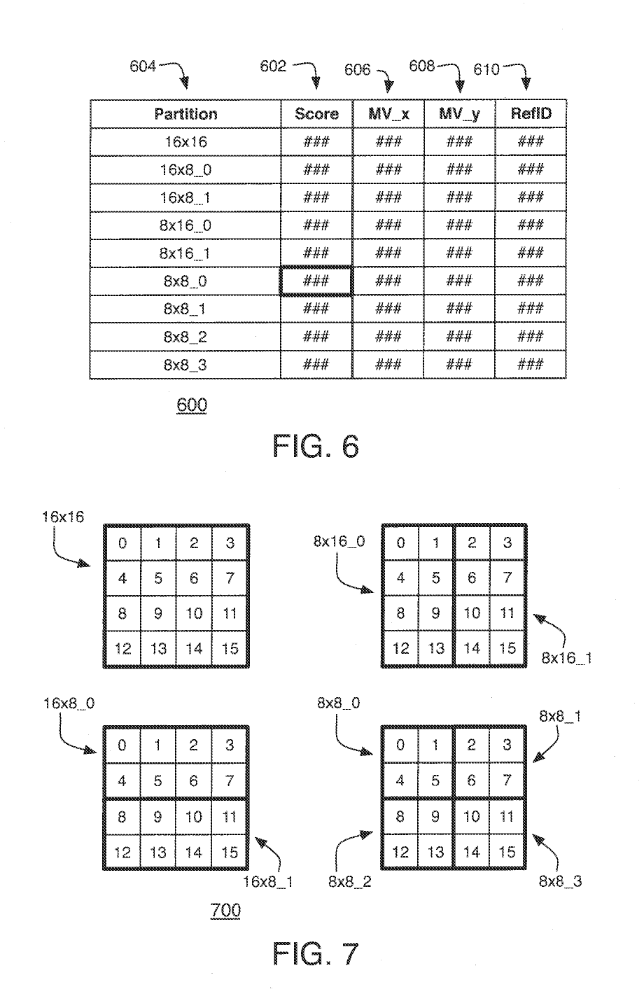

For example, FIG. 6 illustrates example contents of a search result 600 in accordance with the present disclosure that may result from implementing block 402 for a set of example macroblock or sub-macroblock partitions or shape candidates. In various implementations, search result 600 includes a distortion score 602 for each of the set of partition or shape candidates 604, each score 602 corresponding to a best motion vector result for that partition having an x-component 606 and a y-component 608. Each motion vector result may also be associated with a reference identification (RefID) 610 that indicates the reference frame pointed to by the particular motion vector result specified by components 606 and 608.

FIG. 7 illustrates the various known partitions or shape candidates 604 used in the example of FIG. 6. As noted before, the present disclosure is not limited to any particular sizes, shapes and/or combinations of macroblock or sub-macroblock partitions or shape candidates employed in motion search processing in accordance with the present disclosure. Hence, for example, in various implementations, motion vector results may also be obtained for the eight 8×4 sub-macroblock partitions, the eight 4×8 sub-macroblock partitions, and/or the sixteen 4×4 sub-macroblock partitions in addition to and/or instead of the shape candidates 604 shown in result 600.

In various implementations, score 602 may correspond to a score generated using any of a variety of known distortion metrics. For example, score 602 may be generated using the Sum of Absolute Differences (SAD) distortion metric where a smaller number for score 602 may correspond to a motion vector result having lower distortion. In various implementations, one of scores 602 may be a best score corresponding to a best motion vector of results 600. For example, for purely illustrative purposes, the score for sub-macroblock partition 8×8_{—}0 in results 600 (as highlighted in FIG. 6) may correspond to the best motion vector result from undertaking block 402.

Returning to discussion of FIG. 4, process 400 may continue at block 404 where the first search results may be provided as output. In various implementations, block 404 may involve engine 204 streaming out (504) all of the shape candidate search results (e.g., results 600) as input to controller 202 for use in search calls associated with additional predictors and/or for further processing.

At block 406, second search results may be obtained for a second motion predictor, where the first search results may be used as initial conditions for performing a motion search using the second motion predictor. In various implementations, block 406 may involve engine 204 obtaining search results in response to a second search call received from controller 202. For instance, controller 202 may issue a second search call 506 to engine 204 where that call specifies a motion search using predictor 314. In addition, as either part of the second search call 506, or in an associated input message 508, controller 202 may also provide or stream the first search results back to engine 204.

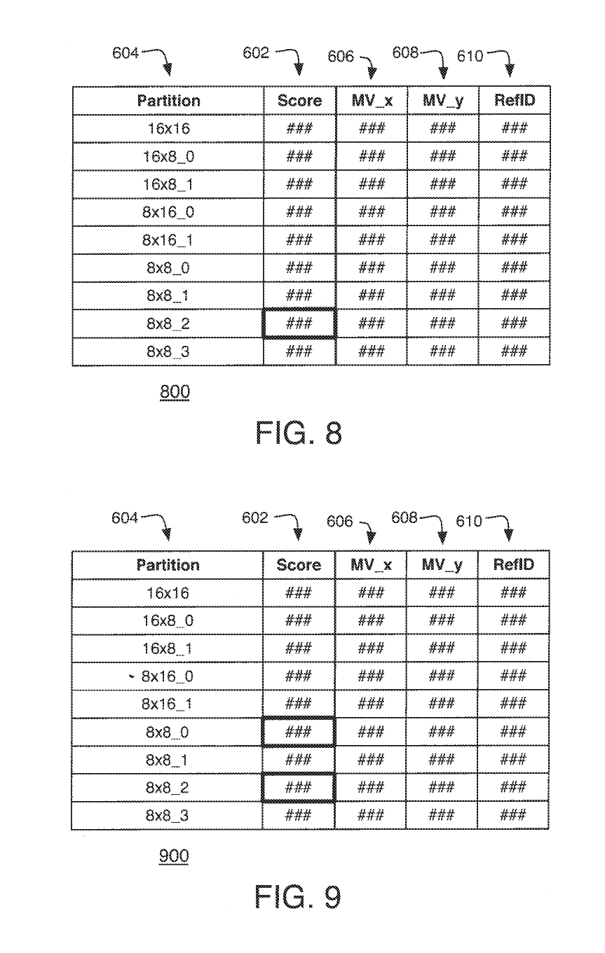

Engine 204 may then use predictor 314 to perform a motion search in region 318 when implementing block 406 to generate a second set of motion vector results for at least the same macroblock or sub-macroblock partitions such as, for example, 16×8, 8×16, 8×8, 8×4, 4×8, or 4×4 partitions, employed at block 402. FIG. 8 illustrates example contents of a search result 800 in accordance with the present disclosure that may result from implementing block 406 for shape candidates 604. For example, for purely illustrative purposes, the score for sub-macroblock partition 8×8_{—}2 in results 800 (as highlighted) may correspond to the best motion vector result when undertaking block 406. In various implementations, using the first search results as initial conditions at block 406 may involve using the first motion vector result for each the macroblock and/or sub-macroblock partitions as an initial search candidate for the motion search using the second predictor.

At block 408, global search results may be generated by combining the first search results with the second search results. For example, in various implementations, engine 204 may undertake block 408 by updating the second search results with the first search results so that, for each partition or shape candidate, engine 204 may determine a best motion vector search result by comparing the motion vector result from block 402 to the motion vector result from block 406 and selecting or retaining in the updated search results the motion vector result having the best score (e.g., having the lowest SAD score). For example, FIG. 9 illustrates example contents of a global search result 900 in accordance with the present disclosure that may result from implementing block 408 for shape candidates 604. For example, global results 900 includes two best motion vector results corresponding to the scores for sub-macroblock partitions 8×8_{—}0 and 8×8_{—}2 in results 900 (as highlighted) obtained from undertaking blocks 402 and 406, respectively.

In various implementations, the results for different shape candidates, such as partitions 8×8_{—}0 and 8×8_{—}2 of result 900, may have different frame reference IDs 610 indicating that the corresponding motion vectors point to different reference frames. In various implementations, by adding reference IDs to a stream in and stream out interface in accordance with the present disclosure, the same interface with the motion vector and distortion information for each shape may also be sent across multiple predictors on multiple reference frames. Thus, the final result of a stream in stream out interface in accordance with the present disclosure may be a composite from multiple references and multiple regions.

Process 400 may continue at block 410 where the global search results may be provided as output. In various implementations, block 410 may involve engine 204 streaming out (510) all of the shape candidate global search results (e.g., global results 900) from block 408 as input to controller 202 for use in search calls associated with additional predictors and/or for further processing.

Process 400 may conclude at block 412 where third search results may be obtained for a third motion predictor, where obtaining the third search results includes using the global search results as initial conditions for performing a motion search using the third motion predictor. In various implementations, block 412 may involve engine 204 obtaining search results in response to a third search call received from controller 202. For instance, controller 202 may issue a third search call 512 to engine 204 where that call specifies a motion search using predictor 320. In addition, as either part of the third search call 512, or in an associated input message 514, controller 202 may also provide or stream global search results (e.g., results 900) back to engine 204.

In various implementations, input messages (e.g., messages 508 and 514) provided to a motion engine may be dynamically sized. For instance, an input message associated with the initial call 502 may be smaller in size, while input messages 508 and 514 may be larger as previous search results are streamed into motion engine 204. For example, in various implementations additional partitions or shape candidates may be added to motion searches performed for various motion predictors. In this regard, multiple stream in or stream out interfaces may be employed such that dynamic message sizing may allow software to more efficiently prepare the calls for the motion engine.

Engine 204 may then use predictor 320 to perform a motion search in region 324 when implementing block 412 to generate a second set of motion vector results for at least the same macroblock or sub-macroblock partitions such as, for example, 16×8, 8×16, 8×8, 8×4, 4×8, or 4×4 partitions, employed at block 406. In various implementations, using the global search results as initial conditions at block 412 may involve using the global motion vector result for each the macroblock and/or sub-macroblock partitions as an initial search candidate for the motion search using the third predictor.

Engine 204 may then update the global results and stream the updated global results (516) back out to controller 202. Although not illustrated in FIG. 4, in various implementations, processes similar to process 400 may be undertaken in accordance with the present disclosure including similar blocks for motion searches undertaken for any number of motion predictors.

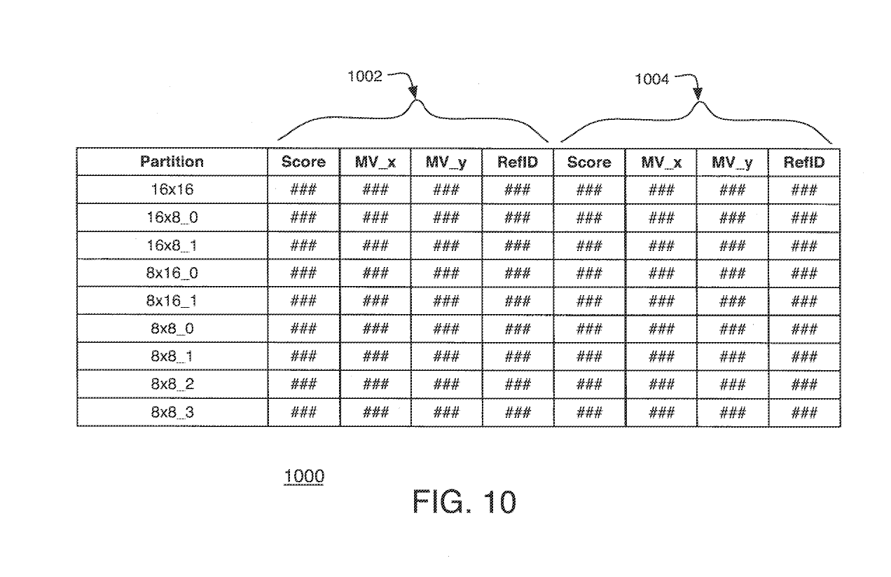

In various implementations, in addition to including a best motion vector result for each partition, a duplicate copy of an interface may contain a second best or up to an Nth best motion vector result for each macroblock or sub-macroblock partition. For example, FIG. 10 illustrates example contents of a search result 1000 in accordance with the present disclosure where result 100 includes best motion vector results 1002 and second best motion vector results 1004 for each shape candidate.

In various implementations, Nth best motion vector results (e.g., results 1002 and 1004) may be used to determine an optimal partition or shape candidate in the event of small differences between each of several alternative shape candidates. In various implementations, information including Nth best motion vector results may be permit further calculations and/or optimizations to be undertaken to, for example, making a mode decision beyond just a distortion metric by performing quantization or other methods.

While implementation of example process 400, as illustrated in FIG. 4, may include the undertaking of all blocks shown in the order illustrated, the present disclosure is not limited in this regard and, in various examples, implementation of process 400 may include the undertaking only a subset of the blocks shown and/or in a different order than illustrated.

In addition, any one or more of the blocks of FIG. 4 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIG. 4 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

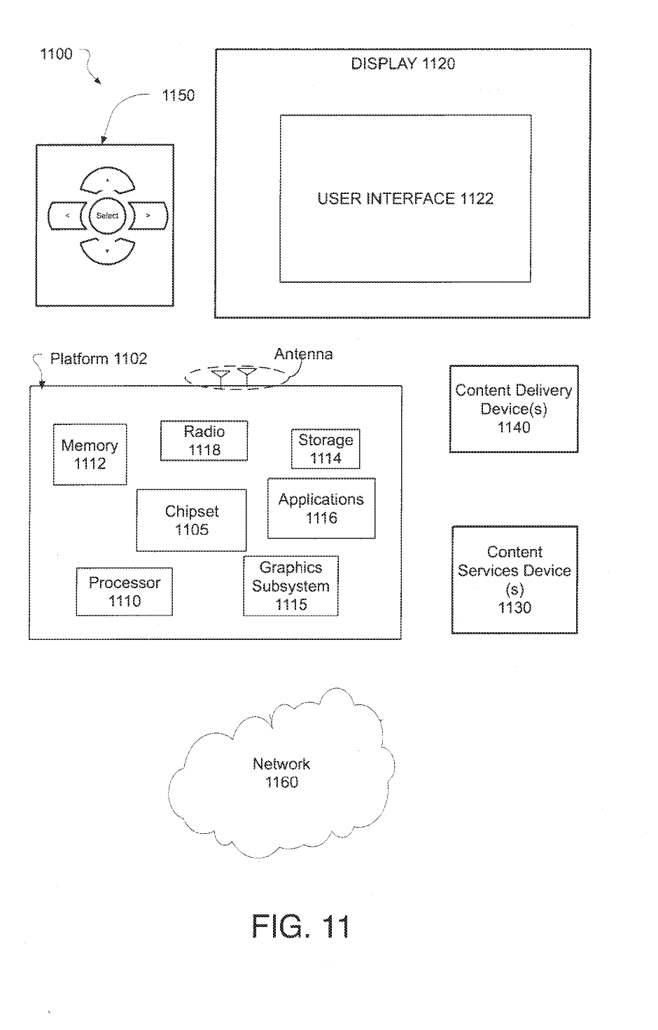

FIG. 11 illustrates an example system 1100 in accordance with the present disclosure. In various implementations, system 1100 may be a media system although system 1100 is not limited to this context. For example, system 1100 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 1100 includes a platform 1102 coupled to a display 1120. Platform 1102 may receive content from a content device such as content services device(s) 1130 or content delivery device(s) 1140 or other similar content sources. A navigation controller 1150 including one or more navigation features may be used to interact with, for example, platform 1102 and/or display 1120. Each of these components is described in greater detail below.

In various implementations, platform 1102 may include any combination of a chipset 1105, processor 1110, memory 1112, storage 1114, graphics subsystem 1115, applications 1116 and/or radio 1118. Chipset 1105 may provide intercommunication among processor 1110, memory 1112, storage 1114, graphics subsystem 1115, applications 1116 and/or radio 1118. For example, chipset 1105 may include a storage adapter (not depicted) capable of providing intercommunication with storage 1114.

Processor 1110 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1110 may be dual-core processor(s), dual-core mobile processor(s), and so forth.

Memory 1112 may be implemented as a volatile memory device such as, but not limited to, a Random Access Memory (RAM), Dynamic Random Access Memory (DRAM), or Static RAM (SRAM).

Storage 1114 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1114 may include technology to increase the storage performance enhanced protection for valuable digital media when multiple hard drives are included, for example.

Graphics subsystem 1115 may perform processing of images such as still or video for display. Graphics subsystem 1115 may be a graphics processing unit (GPU) or a visual processing unit (VPU), for example. An analog or digital interface may be used to communicatively couple graphics subsystem 1115 and display 1120. For example, the interface may be any of a High-Definition Multimedia Interface, DisplayPort, wireless HDMI, and/or wireless HD compliant techniques. Graphics subsystem 1115 may be integrated into processor 1110 or chipset 1105. In some implementations, graphics subsystem 1115 may be a stand-alone card communicatively coupled to chipset 1105.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 1118 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1118 may operate in accordance with one or more applicable standards in any version.

In various implementations, display 1120 may include any television type monitor or display. Display 1120 may include, for example, a computer display screen, touch screen display, video monitor, television-like device, and/or a television. Display 1120 may be digital and/or analog. In various implementations, display 1120 may be a holographic display. Also, display 1120 may be a transparent surface that may receive a visual projection. Such projections may convey various forms of information, images, and/or objects. For example, such projections may be a visual overlay for a mobile augmented reality (MAR) application. Under the control of one or more software applications 1116, platform 1102 may display user interface 1122 on display 1120.

In various implementations, content services device(s) 1130 may be hosted by any national, international and/or independent service and thus accessible to platform 1102 via the Internet, for example. Content services device(s) 1130 may be coupled to platform 1102 and/or to display 1120. Platform 1102 and/or content services device(s) 1130 may be coupled to a network 1160 to communicate (e.g., send and/or receive) media information to and from network 1160. Content delivery device(s) 1140 also may be coupled to platform 1102 and/or to display 1120.

In various implementations, content services device(s) 1130 may include a cable television box, personal computer, network, telephone, Internet enabled devices or appliance capable of delivering digital information and/or content, and any other similar device capable of unidirectionally or bidirectionally communicating content between content providers and platform 1102 and/display 1120, via network 1160 or directly. It will be appreciated that the content may be communicated unidirectionally and/or bidirectionally to and from any one of the components in system 1100 and a content provider via network 1160. Examples of content may include any media information including, for example, video, music, medical and gaming information, and so forth.

Content services device(s) 1130 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1102 may receive control signals from navigation controller 1150 having one or more navigation features. The navigation features of controller 1150 may be used to interact with user interface 1122, for example. In embodiments, navigation controller 1150 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 1150 may be replicated on a display (e.g., display 1120) by movements of a pointer, cursor, focus ring, or other visual indicators displayed on the display. For example, under the control of software applications 1116, the navigation features located on navigation controller 1150 may be mapped to virtual navigation features displayed on user interface 1122, for example. In embodiments, controller 1150 may not be a separate component but may be integrated into platform 1102 and/or display 1120. The present disclosure, however, is not limited to the elements or in the context shown or described herein.

In various implementations, drivers (not shown) may include technology to enable users to instantly turn on and off platform 1102 like a television with the touch of a button after initial boot-up, when enabled, for example. Program logic may allow platform 1102 to stream content to media adaptors or other content services device(s) 1130 or content delivery device(s) 1140 even when the platform is turned “off.” In addition, chipset 1105 may include hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 1100 may be integrated. For example, platform 1102 and content services device(s) 1130 may be integrated, or platform 1102 and content delivery device(s) 1140 may be integrated, or platform 1102, content services device(s) 1130, and content delivery device(s) 1140 may be integrated, for example. In various embodiments, platform 1102 and display 1120 may be an integrated unit. Display 1120 and content service device(s) 1130 may be integrated, or display 1120 and content delivery device(s) 1140 may be integrated, for example. These examples are not meant to limit the present disclosure.

In various embodiments, system 1100 may be implemented as a wireless system, a wired system, or a combination of both. When implemented as a wireless system, system 1100 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1102 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 11.

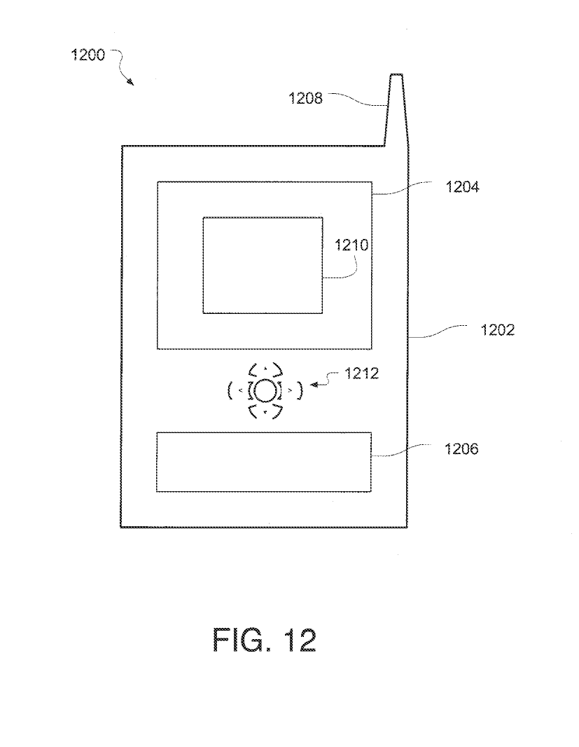

As described above, system 1100 may be embodied in varying physical styles or form factors. FIG. 12 illustrates implementations of a small form factor device 1200 in which system 1100 may be embodied. In embodiments, for example, device 1200 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/iPDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 12, device 1200 may include a housing 1202, a display 1204, an input/output (I/C)) device 1206, and an antenna 1208. Device 1200 also may include navigation features 1212. Display 1204 may include any suitable display unit for displaying information appropriate for a mobile computing device. I/O device 1206 may include any suitable I/O device for entering information into a mobile computing device. Examples for I/O device 1206 may include an alphanumeric keyboard, a numeric keypad, a touch pad, input keys, buttons, switches, rocker switches, microphones, speakers, voice recognition device and software, and so forth. Information also may be entered into device 1200 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

1-30. (canceled)

31. A computer-implemented method, comprising:
reading image data from a source memory, wherein the source memory has a source storage format, wherein the reading of the source memory is in a pattern adapted for the source memory;
transposing the image data from the source storage format to a destination storage format different from the source storage format, wherein one of the source storage format and the destination storage format have a linear-type storage format and the other of the source storage format and the destination storage format have a Y-tiled-type storage format; and
writing image data into a destination memory, wherein the destination memory has the destination storage format, wherein the reading of the destination memory is in a pattern adapted for the destination memory.

32. The method of claim 31, wherein reading image data from the source memory comprises reading image data in the Y-tiled-type storage format via a matrix pattern adapted for the source memory,
wherein the transposing comprises transposing the matrix pattern into a vector pattern adapted for the destination memory, and
wherein writing image data into the destination memory comprises writing image data in the linear-type storage format.

33. The method of claim 31, wherein reading image data from the source memory comprises reading image data in linear-type storage format via a vector pattern adapted for the source memory,
wherein the transposing comprises transposing the vector pattern into a matrix pattern adapted for the destination memory, and
wherein writing image data into the destination memory comprises writing image data in the Y-tiled-type storage format.

34. The method of claim 31, wherein reading image data from the source memory comprises reading image data from four contiguous data blocks of the source memory into sixteen cache lines, wherein each data block comprises eight rows of thirty-two bytes of image data and is associated with the matrix pattern, and
wherein writing image data to the destination memory comprises writing image data from the sixteen cache lines into eight contiguous data lines of the destination memory, wherein each data line comprises one row of one hundred and twenty-eight bytes of image data and is associated with the vector pattern.

35. The method of claim 31, wherein reading image data from the source memory comprises reading image data from eight contiguous data lines of the source memory into sixteen cache lines, wherein each data line comprises one row of one hundred and twenty-eight bytes of image data and is associated with the vector pattern, and
wherein writing image data to the destination memory comprises writing image data from the sixteen cache lines into four contiguous data blocks of the destination memory, wherein each data block comprises eight rows of thirty-two bytes of image data and is associated with the matrix pattern.

36. The method of claim 31, wherein the source memory and the destination memory may share the same physical storage device.

37. The method of claim 31, wherein a plurality of cache line source accesses are performed during the reading of image data from the source memory, wherein all of the space associated with the cache line source accesses is utilized during the writing of image data into the destination memory.

38. The method of claim 31, wherein a plurality of cache line destination accesses are performed during the writing of image data into the destination memory, and wherein all of the space associated with the cache line destination accesses is utilized during the writing of image data into the destination memory.

39. The method of claim 31, wherein reading image data from the source memory comprises reading image data in the Y-tiled-type storage format via a matrix pattern adapted for the source memory,
wherein the transposing comprises transposing the matrix pattern into a vector pattern adapted for the destination memory,
wherein writing image data into the destination memory comprises writing image data in the linear-type storage format,
wherein reading image data from the source memory comprises reading image data from four contiguous data blocks of the source memory into sixteen cache lines, wherein each data block comprises eight rows of thirty-two bytes of image data and is associated with the matrix pattern, and
wherein writing image data to the destination memory comprises writing image data from the sixteen cache lines into eight contiguous data lines of the destination memory, wherein each data line comprises one row of one hundred and twenty-eight bytes of image data and is associated with the vector pattern,
wherein the source memory and the destination memory may share the same physical storage device,
wherein a plurality of cache line source accesses are performed during the reading of image data from the source memory, wherein all of the space associated with the cache line source accesses is utilized during the writing of image data into the destination memory, and
wherein a plurality of cache line destination accesses are performed during the writing of image data into the destination memory, and wherein all of the space associated with the cache line destination accesses is utilized during the writing of image data into the destination memory.

40. The method of claim 31, wherein reading image data from the source memory comprises reading image data in linear-type storage format via a vector pattern adapted for the source memory,
wherein the transposing comprises transposing the vector pattern into a matrix pattern adapted for the destination memory,
wherein writing image data into the destination memory comprises writing image data in the Y-tiled-type storage format,
wherein reading image data from the source memory comprises reading image data from eight contiguous data lines of the source memory into sixteen cache lines, wherein each data line comprises one row of one hundred and twenty-eight bytes of image data and is associated with the vector pattern,
wherein writing image data to the destination memory comprises writing image data from the sixteen cache lines into four contiguous data blocks of the destination memory, wherein each data block comprises eight rows of thirty-two bytes of image data and is associated with the matrix pattern,
wherein the source memory and the destination memory may share the same physical storage device,
wherein a plurality of cache line source accesses are performed during the reading of image data from the source memory, wherein all of the space associated with the cache line source accesses is utilized during the writing of image data into the destination memory, and
wherein a plurality of cache line destination accesses are performed during the writing of image data into the destination memory, and wherein all of the space associated with the cache line destination accesses is utilized during the writing of image data into the destination memory.

41. An article comprising a computer program product having stored therein instructions that, if executed, result in:
reading image data from a source memory, wherein the source memory has a source storage format, wherein the reading of the source memory is in a pattern adapted for the source memory;
transposing the image data from the source storage format to a destination storage format different from the source storage format, wherein one of the source storage format and the destination storage format have a linear-type storage format and the other of the source storage format and the destination storage format have a Y-tiled-type storage format; and
writing image data into a destination memory, wherein the destination memory has the destination storage format, wherein the writing of the destination memory is in a pattern adapted for the destination memory.

42. The article of claim 41, wherein reading image data from the source memory comprises reading image data in linear-type storage format via a vector pattern adapted for the source memory,
wherein the transposing comprises transposing the vector pattern into a matrix pattern adapted for the destination memory,
wherein writing image data into the destination memory comprises writing image data in the Y-tiled-type storage format,
wherein reading image data from the source memory comprises reading image data from eight contiguous data lines of the source memory into sixteen cache lines, wherein each data line comprises one row of one hundred and twenty-eight bytes of image data and is associated with the vector pattern,
wherein writing image data to the destination memory comprises writing image data from the sixteen cache lines into four contiguous data blocks of the destination memory, wherein each data block comprises eight rows of thirty-two bytes of image data and is associated with the matrix pattern,
wherein the source memory and the destination memory may share the same physical storage device,
wherein a plurality of cache line source accesses are performed during the reading of image data from the source memory, wherein all of the space associated with the cache line source accesses is utilized during the writing of image data into the destination memory, and
wherein a plurality of cache line destination accesses are performed during the writing of image data into the destination memory, and wherein all of the space associated with the cache line destination accesses is utilized during the writing of image data into the destination memory.

43. An apparatus, comprising:
a processor configured to:
read image data from a source memory, wherein the source memory has a source storage format, wherein the read of the source memory is in a pattern adapted for the source memory;
transpose the image data from the source storage format to a destination storage format different from the source storage format, wherein one of the source storage format and the destination storage format have a linear-type storage format and the other of the source storage format and the destination storage format have a Y-tiled-type storage format; and
write image data into a destination memory, wherein the destination memory has the destination storage format, wherein the write of the destination memory is in a pattern adapted for the destination memory.

44. The apparatus of claim 43, wherein the read of image data from the source memory comprises a read of image data in the Y-tiled-type storage format via a matrix pattern adapted for the source memory,
wherein the transpose comprises a transpose of the matrix pattern into a vector pattern adapted for the destination memory, and
wherein the write of image data into the destination memory comprises a write of image data in the linear-type storage format.

45. The apparatus of claim 43, wherein the read of image data from the source memory comprises a read of image data in linear-type storage format via a vector pattern adapted for the source memory,
wherein the transpose comprises a transpose of the vector pattern into a matrix pattern adapted for the destination memory, and
wherein the write of image data into the destination memory comprises a write of image data in the Y-tiled-type storage format.

46. The apparatus of claim 43, wherein the read of image data from the source memory comprises a read of image data from four contiguous data blocks of the source memory into sixteen cache lines, wherein each data block comprises eight rows of thirty-two bytes of image data and is associated with the matrix pattern, and
wherein the write of image data to the destination memory comprises a write of image data from the sixteen cache lines into eight contiguous data lines of the destination memory, wherein each data line comprises one row of one hundred and twenty-eight bytes of image data and is associated with the vector pattern.

47. The apparatus of claim 43, wherein the read of image data from the source memory comprises a read of image data from eight contiguous data lines of the source memory into sixteen cache lines, wherein each data line comprises one row of one hundred and twenty-eight bytes of image data and is associated with the vector pattern, and
wherein the write of image data to the destination memory comprises a write of image data from the sixteen cache lines into four contiguous data blocks of the destination memory, wherein each data block comprises eight rows of thirty-two bytes of image data and is associated with the matrix pattern.

48. The apparatus of claim 43, wherein a plurality of cache line source accesses are performed during the read of image data from the source memory, wherein all of the space associated with the cache line source accesses is utilized during the write of image data into the destination memory, and
wherein a plurality of cache line destination accesses are performed during the write of image data into the destination memory, and wherein all of the space associated with the cache line destination accesses is utilized during the write of image data into the destination memory.

49. A system comprising:
a display;
a processor, wherein the processor is communicatively coupled to the display, wherein the processor configured to:
read image data from a source memory, wherein the source memory has a source storage format, wherein the read of the source memory is in a pattern adapted for the source memory;
transpose the image data from the source storage format to a destination storage format different from the source storage format, wherein one of the source storage format and the destination storage format have a linear-type storage format and the other of the source storage format and the destination storage format have a Y-tiled-type storage format; and
write image data into a destination memory, wherein the destination memory has the destination storage format, wherein the write of the destination memory is in a pattern adapted for the destination memory.

50. The system of claim 49, wherein the read of image data from the source memory comprises a read of image data in the Y-tiled-type storage format via a matrix pattern adapted for the source memory,
wherein the transpose comprises a transpose of the matrix pattern into a vector pattern adapted for the destination memory, and
wherein the write of image data into the destination memory comprises a write of image data in the linear-type storage format.

51. The system of claim 49, wherein the read of image data from the source memory comprises a read of image data in linear-type storage format via a vector pattern adapted for the source memory,
wherein the transpose comprises a transpose of the vector pattern into a matrix pattern adapted for the destination memory, and
wherein the write of image data into the destination memory comprises a write of image data in the Y-tiled-type storage format.

52. The system of claim 49, wherein the read of image data from the source memory comprises a read of image data from four contiguous data blocks of the source memory into sixteen cache lines, wherein each data block comprises eight rows of thirty-two bytes of image data and is associated with the matrix pattern, and
wherein the write of image data to the destination memory comprises a write of image data from the sixteen cache lines into eight contiguous data lines of the destination memory, wherein each data line comprises one row of one hundred and twenty-eight bytes of image data and is associated with the vector pattern.

53. The system of claim 49, wherein the read of image data from the source memory comprises a read of image data from eight contiguous data lines of the source memory into sixteen cache lines, wherein each data line comprises one row of one hundred and twenty-eight bytes of image data and is associated with the vector pattern, and
wherein the write of image data to the destination memory comprises a write of image data from the sixteen cache lines into four contiguous data blocks of the destination memory, wherein each data block comprises eight rows of thirty-two bytes of image data and is associated with the matrix pattern.

54. The system of claim 49, wherein a plurality of cache line source accesses are performed during the read of image data from the source memory, wherein all of the space associated with the cache line source accesses is utilized during the write of image data into the destination memory, and
wherein a plurality of cache line destination accesses are performed during the write of image data into the destination memory, and wherein all of the space associated with the cache line destination accesses is utilized during the write of image data into the destination memory.
